(19) United States
(12) Patent Application Publication
(10) Pub. No.: US 2012/0096018 A1
(43) Pub. Date: Apr. 19, 2012

(54) METHOD AND SYSTEM FOR SELECTING MUSIC

(76) Inventor: Michael D. Metcalf, Lake Forest, CA (US)

(21) Appl. No.: 13/274,323

(22) Filed: Oct. 15, 2011

Related U.S. Application Data
(60) Provisional application No. 61/393,877, filed on Oct. 16, 2010.

(51) Int. Cl. G06F 17/30

(52) U.S. Cl. 707/758; 707/E17.014

(57) ABSTRACT

A method for selecting music and directing disposal thereof includes a step of providing a service with a database having music information stored therein and a user interface platform coupled to the database and accessible through a telecommunication device. A communication is received including a request for music from an external telecommunication device. An instruction is provided to the external telecommunication device for a song designator including one of a title, artist and/or lyric by one of voiced information, typed information, and a music source. The song designator is received from the external telecommunication device and the song designator is compared to music information stored in the database to determine the music requested. The telecommunication device is queried to determine a desired disposal of the requested music. The method can be performed with videos—search, upload, share, watch/listen.

### CROSS-REFERENCE TO RELATED APPLICATION

This application claims the benefit of U.S. Provisional Patent Application No. 61/393,877, filed 16 Oct. 2010.

### FIELD OF THE INVENTION

This invention relates to selecting music.

More particularly, the present invention relates to selecting music by voice over a telecommunication device.

### BACKGROUND OF THE INVENTION

In the music industry, at the present time, there are large numbers of available recorded music so that an individual wishing to listen to a specific song or songs of a specific artist may have difficulty finding or selecting the desired music. Sorting through extensive lists of music, songs, artists etc. can be both time consuming and undesirable. Thus, an interface application that allows interaction of a user with the application by voice and optionally via other media such as visual displays, touch screens, pen input, etc., would be highly desirable. It is preferable that in such an interface finding a song can be accomplished in a very short period of time, with hands free operation on any telephone, and can be easily shared with friends. Further, it is desirable that a user can locate desired music with the aid of the application, and direct the purchase or sharing of the selected music.

It would be highly advantageous, therefore, to provide methods and apparatus to remedy the foregoing and other deficiencies inherent in the prior art.

Accordingly, it is an object of the present invention to provide new and improved methods and apparatus for selecting desired music.

It is another object of the present invention to provide new and improved methods and apparatus for using a song designator such as a title, artist and/or lyric for selecting requested music.

It is another object of the present invention to provide new and improved methods and apparatus for selecting requested music including simply speaking the information known.

### SUMMARY OF THE INVENTION

Briefly, to achieve the desired objects of the instant invention in accordance with a preferred embodiment thereof, a method for selecting music and directing disposal thereof includes a step of providing a service with a database having music information stored therein and a user interface platform coupled to the database and accessible through a telecommunication device. A communication is received including a request for music from an external telecommunication device. An instruction is provided to the external telecommunication device for a song designator including one of a title, artist and/or lyric by one of voiced information, typed information (includes touch screen touches, mouse clicks, etc.), and a music source. The song designator is received from the external telecommunication device and the song designator is compared to music information stored in the database to determine the music requested. The telecommunication device is queried to determine a desired disposal of the requested music. The method can be performed with videos—search, upload, share, watch/listen.

The desired objects of the instant invention can be further achieved in accordance with a preferred embodiment, in which apparatus for selecting music and directing disposal thereof is utilized. The apparatus comprises a service including a database having music information stored therein and a user interface platform coupled to the database and accessible through a telecommunication device. The interface platform includes software designed to receive a request for music from an external telecommunication device, software designed to provide an instruction to the external telecommunication device for a song designator including one of a title, artist and/or lyric by one of voiced information, typed information, and a music source, and software designed to receive the song designator from the external telecommunication device and compare the song designator to music information stored in the database to determine the music requested. The interface platform further includes software designed to query the telecommunication device to determine a desired disposal of the requested music.

### BRIEF DESCRIPTION OF THE DRAWINGS

Specific objects and advantages of the instant invention will become readily apparent to those skilled in the art from the following detailed description of a preferred embodiment thereof taken in conjunction with the drawings, in which:

FIG. 1 is a simplified block diagram of a system according to the present invention; and

FIG. 2 is a flow diagram of a method of use of the system.

### DETAILED DESCRIPTION OF THE PREFERRED EMBODIMENT

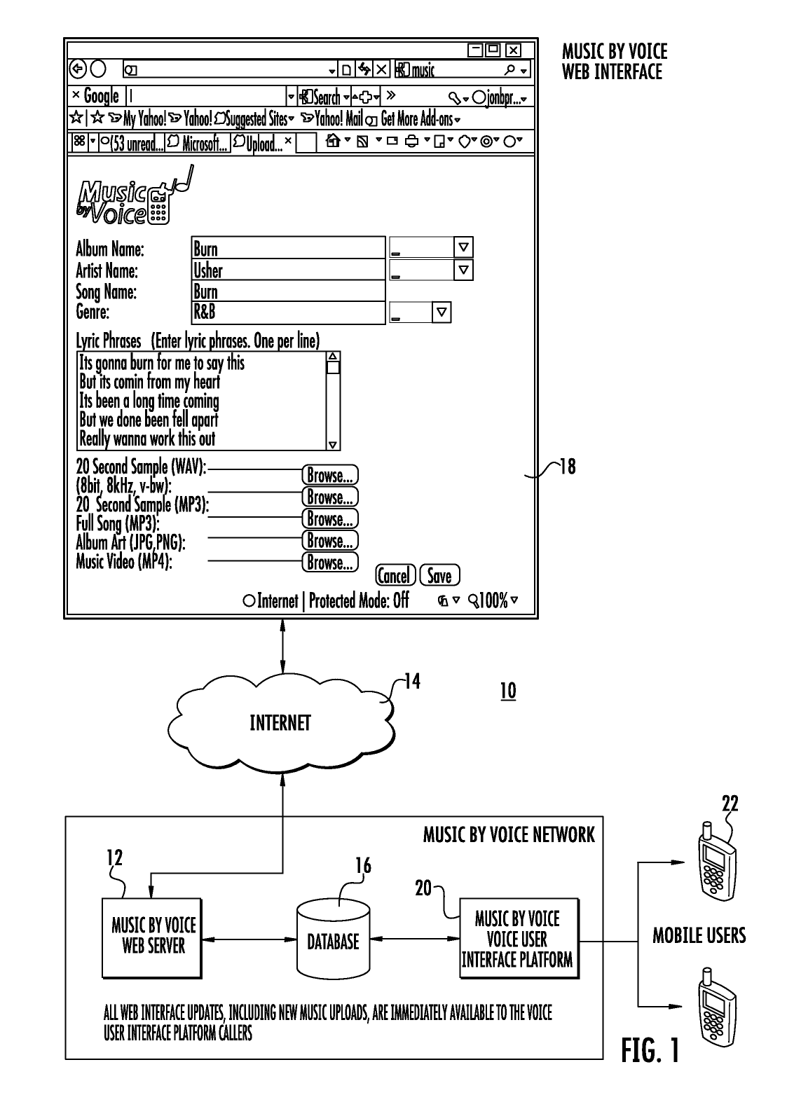

Turning now to the drawings in which like reference characters indicate corresponding elements throughout the several views, attention is directed to FIG. 1 which illustrates a music selection system generally designated 10. System 10 includes a music selection web server 12 supporting a music application, coupled through a network such as the Internet 14. Web server 12 can store and retrieve data from a database 16 and is preferably accessible by two interfaces. A music upload interface 18 is accessible from web server 12 through a network such as Internet 14. Upload interface 18 permits music owners or representatives to provide music for system 10. Information is input through upload interface 18 and stored in database 16. The information can include an album name, artist name, song name, genre, lyric phrases, a sample of the song (e.g. 20 seconds in length), and the full song. Album art and music videos can also be uploaded. In this manner, songs are cataloged and saved to database 16.

Another interface is a user interface 20. User interface 20 facilitates the selection of music stored in database 16 by a user from a telecommunication device 22. Telecommunication device 22 preferably includes mobile devices such as cell phone, VoIP phone, smart phone, tablet, telematics (in-car systems), multimedia PC, home entertainment system, and the like, but is not limited thereto. A user, employing telecommunication device 22, calls the host of the music application (service), and interacts with user interface 20 which includes a Voice User Interface (VUI). The VUI allows interaction of the user with the music application by voice and optionally via other media such as visual displays, touch screens, text, pen input, etc., and, in one embodiment, is provided as a subscription service. Generally, the various functions of user interface 20 are accomplished by software, much of which is known individually in the industry, and may include various “machines” (in the form of software or hardware) for performing specialized functions such as a pitch detector, a speech recognizer, or a combination thereof. Thus, a user can access music database 16 with a telecommunication device 22, locate desired music with the aid of the hosted music application, and direct the purchase or sharing of the selected music. Finding a song can be accomplished in a very short period of time, with hands free operation on any telephone, and can be easily shared with friends. The process of finding a song may be enhanced by phones with data or SMS messaging capability.

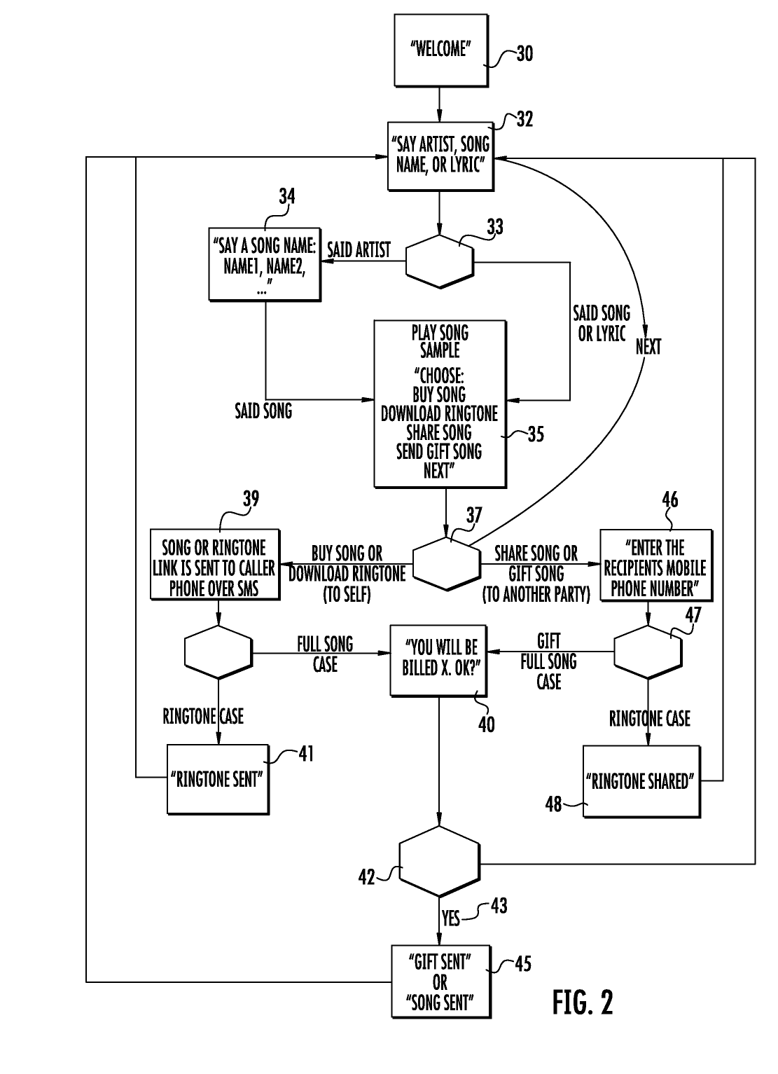

Turning now to FIG. 2, a method of selecting music and directing disposal thereof is illustrated. When a call is placed to the host of the music application, a welcome greeting 30 is played, and a song designator such as a title, artist and/or lyric is requested 32. The user simply speaks the information known 33. In a first alternative embodiment, the user sings or hums a portion of the song, in which case a pitch detector, a speech recognizer, or a combination of both is used in VUI platform 20 to identify the song. In a second embodiment, the user positions telecommunication device 22 and/or a music source such as a radio or public address system such that the telecommunication device 22 can pick up a segment of the song, in which case system 10 may determine the song title based on the portion of the audio picked up. In a third embodiment, the user types relevant information such as artist, title, lyrics, etc., using a text input and said relevant information is received by the service. It will be understood that typed information can include touch screen touches, mouse clicks and the like.

If an artist name is spoken, a song name is requested 34. One variation of the actions depicted by blocks 32, 33, and 34 is to prompt the user to provide whatever information he/she knows as freeform input. System 10 then determines whether the input best matches one or more of an artist, album title, lyrics, song title, melody.

If a song name or lyric is spoken or if the user utterance can be used to identify a song title, artist, album, etc., the hosted application searches through database 16 to find the desired information, and, in one embodiment, a sample, comprising all or part of the song, is played to confirm it is the correct song. In an alternate embodiment, one or more matches that may correspond to song titles are displayed on a display. The user may then select and/or confirm one or more of the matches by voice commands, touching the screen, etc.

A way to match spoken lyrics to the song is to convert the spoken utterance to text, then match text to database 16 of song lyrics as entered at upload interface 18. However, since some songs have lyrics in common, errors can arise from insufficient lyrics. A best match strategy can be employed if the lyrics don't match exactly. If the series of words matches lyrics of multiple songs, the system may ask the caller clarifying questions such as reading back a section of lyrics, playing a sample of the song or citing the song title or artist. Another solution is to identify the song by combining one or more sources of information such as the lyrics spoken by the caller, prosody (pitch and/or duration of each syllable) of the words as sung or recited by the caller, and/or popularity of songs in a database, as determined, for example, by previous callers or by publicly available music billboard charts. For example, songs that are requested more often by callers are more likely to be those requested by a given caller in cases where the match may be otherwise ambiguous. Other useful information can include release date of the song, song types, genres, years, and other characteristics of songs typically requested by the caller. As the caller uses the service, the host learns about preferences and willingness to pay.

Instead of or in combination with text searching, a match in the phoneme domain can be employed. Phonemes are basic sounds in a given language, such as “ah,” which is the “a” sound in “father,” which is the “a” sound in “hay”, etc. Since phonemes exist independent of spelling (e.g. “your,” “yore,” and “you're” are spelled differently, but are represented by the same set of phonemes), they tend to be an alternate way of matching spoken words to text. Specifically, the host of the service can convert song lyrics for a given song to a first phoneme set and store such sets for multiple songs in database 16. Then the host can convert the spoken utterance from the caller to a second phoneme set using an automatic speech recognizer. The host can then search the song lyrics database for a string of phonemes from the first set that best matches the second phoneme set from the caller. This match may be enhanced by including prosody, release dates, and other information sources described above. The user may also be allowed to select from a list of possible matches.

Still referring to FIG. 2, the user is then provided with a list of instructions 35 that can be provided such as via spoken commands, a touch screen, etc. The list can include, for example, listen to song, buy song, download ringtone, share song, search for or link to a video containing or related to the song, send gift song or next. The user provides (by voice or otherwise) an instruction 37. If the instruction “next” is provided, song information is again requested 32. If the instruction “buy song” or “download ringtone” is provided, a link to the song or ringtone of the song can be sent to phone 22 as an SMS message 39, in the preferred embodiment, email, shared on social media networks and the like. If “listen to song” is selected by the user, the song plays directly, such as via the telecommunications connection or by downloading or streaming a wave file and playing the file from the device. The user may be charged for listening or the “listen to song” may be complimentary. After the song has been played, the system may, for example, wait for user input, play another song, cut to a radio or TV/movie station (online or broadcast), invite the user to purchase the song or album, or provide any of a number of various other options such as linking to other websites, selecting more songs, getting more information, etc.

In the case of a ringtone, the ring tone link is sent 41 and the process can begin again with song information being requested 32. In the case of a full song, an additional prompt 40 will ask if billing a specified amount for the song is OK, to confirm purchase. A positive or negative response 42 is given by the user. If a positive response 43 is given, the song is sent 45, and the user billed. Billing is accomplished through the user's service provider and can be simply added to the phone bill. If the instruction “share song” or “gift song” is provided, a prompt 46 will request the recipient's mobile phone number. The user then selects 47 to share a ring tone 48 or gift a full song. The ringtone or song will then be sent to the recipient as a link in a SMS message in the preferred embodiment or via email or social networks and the like. If a full song is sent, a billing confirmation 40 is requested. If no charge is desired, or an action is completed, the process can begin again with song information being requested 32. In this manner, songs can be found and selected, and actions such as sharing or purchasing accomplished simply by speaking into telecommunication device 22.

Once the correct song is identified, the service may leverage the caller's interest in the song to promote similar songs the caller is also likely to enjoy, movies, TV shows, YouTube-type videos, paraphernalia (T-shirts, etc.), or websites related to the song, new releases by the same artist and concert schedules and tickets. In one embodiment, the caller receives an advertisement, for example in the form of an audio ad before and/or after the song, one or more images displayed on the display comprising one or more of text, image, or video, or a message transmitted to the caller via email or other transmitting means. In one embodiment, the advertisement is responsive to information about the caller (e.g. age, gender, calling patterns, subscription type, device type, shopping history) or the callers music choices (song selection, the demographic of typical callers with similar interests, etc.).

Various alterations or adaptations are also contemplated, for example, in addition to allowing the caller to download or share the song or ringtone, the host can allow the caller to listen to the song once, thereafter they must buy it, listen, download, or share the song supported by ads, ask for recommendations for similar songs, or sell the song, keeping some of the profit. For example, the caller may text a link to friends recommending the song. The caller may earn a few cents or credit towards future purchases. The caller's song choice at the moment or over a period of time such as the past week may be displayed on a web page associated with the caller such as a Facebook or Twitter page. For example, a line on a social networking page may read, “What I'm listening to right now,” or “What I've listened to today” and invite and/or provide a link for others to comment or listen themselves. Other methods of leveraging this process is to listen to/watch promotional material such as artist interviews or music videos, subscribe to a radio station (a web site channel such as pandora.com available via a home PC or cell phone) featuring similar music, join a fan club (like a Facebook group) where you can post comments, IM or conference call with users having similar music interests, or link to other users as friends, or send a coupon to a friend as a gift. This coupon may be used to purchase any song. When songs or coupons are sent to a friend, the friend may not be a subscriber to the hosted application, so they may also be sent a link or ad inviting them to subscribe to service, optionally with a free trial offer. Everything described herein with respect to music, can also be done with videos—search, upload, share, watch/listen. Videos could be music videos, TV shows, movies, or videos created by the subscriber.

Various changes and modifications to the embodiment herein chosen for purposes of illustration will readily occur to those skilled in the art. To the extent that such modifications and variations do not depart from the spirit of the invention, they are intended to be included within the scope thereof, which is assessed only by a fair interpretation of the following claims. Having fully described the invention in such clear and concise terms as to enable those skilled in the art to understand and practice the same, the invention claimed is:

1. A method for selecting one of music and videos and directing disposal thereof comprising the steps of:
providing a service including a database having one of music and video information stored therein and a user interface platform coupled to the database and accessible through a telecommunication device;
receiving a communication including a request for one of music and a video from an external telecommunication device;
providing an instruction to the external telecommunication device for one of a music and a video designator including one of a title, artist and/or lyric by one of voiced information, typed information, and one of a music and a video source;
receiving the one of music and video designator from the external telecommunication device and comparing the one of music and video designator to one of music and video information stored in the database to determine the one of music and video requested; and
querying the telecommunication device to determine a desired disposal of the requested one of music and video.

2. A method as claimed in claim 1 wherein the one of music and video information stored in the database includes album names, artists names, song names, genre, lyric phrases, samples of the songs, and the full song or video.

3. A method as claimed in claim 1 wherein the user interface platform includes a Voice User Interface (VUI) designed to interpret interactions of the user by one of voice, visual displays, touch screens, keyboard and pen inputs.

4. A method as claimed in claim 1 wherein the desired disposal of the requested one of music and video includes one of buy song or video, download ringtone, share song or video, listen to song, watch video and gift song or video.

5. A method as claimed in claim 1 wherein the service is designed to receive a communication from an external telecommunication device including any of a cell phone, a VoIP phone, a smart phone, a tablet, a telematics (in-car systems), a multimedia PC, and a home entertainment system.

6. A method as claimed in claim 1 wherein the step of comparing the one of music and video designator includes using one of a pitch detector, a speech recognizer, and a combination thereof to identify the requested song.

7. A method as claimed in claim 1 wherein subsequent to the step of comparing the one of music and video designator to one of music and video information stored in the database a sample, comprising all or part of a determined one of music and video, is played to the telecommunication device to confirm a correct requested one of music and video has been identified.

8. A method as claimed in claim 1 wherein subsequent to the step of querying the telecommunication device to determine a desired disposal of the requested one of music and video an advertisement is communicated to the telecommunication device in the form of an audio ad before and/or after the one of music and video, one or more images displayed on the display comprising one or more of text, image, or video, or a message transmitted to the caller via email.

9. A method as claimed in claim 1 wherein the selecting of videos includes music videos, TV shows, movies, or videos created by a subscriber.

10. A method as claimed in claim 1 wherein the step of comparing the one of music and video designator to one of music and video information stored includes combining one or more sources of information.

11. A method as claimed in claim 10 wherein the step of combining one or more sources includes lyrics spoken by the caller, prosody (pitch and/or duration of each syllable) of the words as sung or recited by the caller, and/or popularity of songs in a database, as determined by previous callers or by publicly available music billboard charts.

12. A method as claimed in claim 1 wherein the step of comparing the one of music and video designator to one of music and video information stored includes converting song lyrics for a given song to a first phoneme set and storing first phoneme sets for multiple songs in the database, and converting spoken utterances from the telecommunications device to a second phoneme set using an automatic speech recognizer, and searching the song lyrics database for a string of phonemes from the first set that best matches the second phoneme set.

13. A method as claimed in claim 12 wherein the step of searching the song lyrics database is enhanced by including prosody, release dates, and other information.

14. A method for selecting music and directing disposal thereof comprising the steps of:
providing a service including a database having music information stored therein and a user interface platform coupled to the database and accessible through a telecommunication device;
receiving a communication including a request for music from an external telecommunication device;
providing an instruction to the external telecommunication device for a song designator including one of a title, artist and/or lyric by one of voiced information, typed information, and a music source;
receiving the song designator from the external telecommunication device and comparing the song designator to music information stored in the database to determine the music requested; and
querying the telecommunication device to determine a desired disposal of the requested music.

15. Apparatus for selecting music and directing disposal thereof comprising:
a service including a database having music information stored therein and a user interface platform coupled to the database and accessible through a telecommunication device;
the interface platform including software designed to receive a request for music from an external telecommunication device;
the interface platform including software designed to provide an instruction to the external telecommunication device for a song designator including one of a title, artist and/or lyric by one of voiced information, typed information, and a music source;
the interface platform including software designed to receive the song designator from the external telecommunication device and compare the song designator to music information stored in the database to determine the music requested; and
the interface platform including software designed to query the telecommunication device to determine a desired disposal of the requested music.

16. The apparatus of claim 15 wherein the interface platform includes one of a pitch detector, a speech recognizer, and a combination thereof.
